(19) United States
(12) Patent Application Publication
(10) Pub. No.: US 2007/0095124 A1
(43) Pub. Date: May 3, 2007

(54) Inertial north finder

(76) Inventor: Michael Naroditsky, Carmiel (IL)

Correspondence Address: Mark M. Friedman;c/o Polkinghorn, 9003 Florin Way, Upper Marlboro, MD, 20772, US

(21) Appl. No.: 10/577,859

(22) PCT Filed: Jan. 22, 2004
(86) PCT No.: PCT/IL04/00066

§ 371 Date: Oct. 27, 2006

(30) Foreign Application Priority Data
Jan. 23, 2003 (IL) 154103

(51) Int. Cl. G01C 25/00

(52) U.S. Cl. 73/1.78

(57) ABSTRACT

A non-gyroscopic inertial seeker system for determining the azimuth of a body relative to the true North. The system includes a fluid rotor angular accelerometer which provides a periodic output signal, and means to extract the body azimuthal direction relative to the true North from the periodic output.

### FIELD AND BACKGROUND OF THE INVENTION

The present invention relates to direction finding, and, more particularly, to a method and apparatus for determining the orientation of a body, such as a vehicle or a theodolite; relative to a local coordinate system.

Many methods and devices are known for determining the geographic heading of a body such as a vehicle. A summary of North finding techniques can be found in chapter 9 of “Strapdown inertial navigation technology” by D. H. Titterton and J. L. Weston, ISBN 0863412602, IEE Publishing, England. Magnetic compasses, which are among the oldest of such devices, find the direction of magnetic North, rather than geographic North, so their readings must be corrected for the local deviation of magnetic North from geographic North. More modern methods and devices include gyrocompasses and methods based on signals received from external transmitters such as the GPS satellite network. Gyro-compassing performance (accuracy and duration) is very sensitive to a gyroscope's drift. The process is very long, usually lasting between 10 minutes and 40 minutes. For high accuracy, a very expensive gyroscope must be used. The methods based on external signals are, by definition, not autonomous.

Methods and devices using accelerometers for determining the geographic heading of a body are also known. They include U.S. Pat. No. 6,502,055 to Reiner et al. and the references cited therein, in particular the paper by Sun et al., “Accelerometer based North finding system”, IEEE, Mar. 13-16, 2000. Sun et al. use one or more linear accelerometers to find North. Sun's and similar systems based on linear accelerometers suffer from two main disadvantages:

a) all linear accelerometers measure linear vibration in addition to Coriolis acceleration. The magnitude of a Coriolis acceleration due to earth rotation is no more than 150-200 μG. Identification of this acceleration is too difficult on the background of a typical field linear vibration (10-50 mG).

b) use of a system such as Sun's is possible only in a vertical position of the rotative axis, because a tilt of the accelerometer rotative base coupled with the accelerometer residual misalignment provide a disturbance, which induces a non-separable error to the azimuth measurement.

In contrast with all accelerometer-based prior art North finding systems that use linear accelerometers, the system of the present invention uses an angular accelerometer, specifically a fluid rotor angular accelerometer. An angular accelerometer is a single axis non-gyroscopic device, which provides an electrical signal proportional to angular acceleration. Angular accelerometers that use the fluid rotor concept shown in FIG. 1 are known in the art, described for example in section 6.6.1, chapter 6 of Titterton and Weston above, and manufactured for example by Columbia Research Laboratories, Inc 1925 Mac Dade Blvd. Woodlyn, Pa. 19094, or Jewell Instruments LLC, 850 Perimeter Road, Manchester, N.H. 03103, USA. FIG. 1 shows a fluid containing toroidal vessel 10 that rotates clockwise around a central symmetry axis 12, which is perpendicular to (coming out of) the plane of the page. Vessel 10 is defined by an internal diameter 14, a mean radius R and an external diameter 18. Toroidal vessel 10 includes a sensing element, preferably a piezo-deflection element, most preferably a piezo-ceramic transducer membrane 20, for transducing the fluid pressure into an electrical signal. When static, membrane 20 is parallel to a radial direction 22. When deflected by an inertial force Fᵢ, membrane 20 produces an electrical output. If only the alternating component of angular acceleration is needed for the measurement, the piezo-ceramic membrane pickoff can be used for measuring angular acceleration. Such fluid rotor accelerometers are advantageous in that a homogeneous non-compressible fluid provides ruggedness under linear vibration and acceleration.

In terms of principle of operation, the angular acceleration (out of plane) 6) of a fluid of mass “m” positioned on a toroidal vessel at a mean radius R is related to the inertial force Fᵢ applied to the piezoceramic membrane by
Fᵢ=mRω (1)

The electrical output of the device is:
Uₒᵤₜ=k_{piezo}mRω (2)
where k_{piezo} is the piezo-ceramic transducer scale factor.

In view of the disadvantages existing in prior art linear accelerometer-based direction finders, there is a widely recognized need for, and it would be highly advantageous to have, a North finding seeker that does not use linear accelerometers with their attendant disadvantages.

### SUMMARY OF THE INVENTION

According to the present invention there is provided a non-gyroscopic inertial seeker system for determining the azimuth of a body relative to the true North direction, comprising a fluid rotor angular accelerometer positioned on and revolving on the body, the accelerometer providing a periodic output signal, and means to extract from the periodic output signal the body azimuthal direction relative to the true North direction.

According to the present invention there is provided a method for determining the azimuth of a body relative to the true North direction, comprising steps of providing a fluid rotor angular accelerometer, the accelerometer including at least one Coriolis force sensing element, rotating the angular accelerometer relative to the body to provide a periodic output signal correlated with a body direction, and using the periodic output signal to determine the azimuth of said body direction relative to the true North direction.

### BRIEF DESCRIPTION OF THE DRAWINGS

The invention is herein described, by way of example only, with reference to the accompanying drawings, wherein:

FIG. 1 is a schematic description of the fluid rotor angular accelerometer concept;

FIG. 2 is a schematic description of Coriolis force measurement using a toroidal fluid rotor angular accelerometer;

FIG. 3 shows schematically a preferred embodiment of the system for North seeking of the present invention;

FIG. 4 shows the output of the angular accelerometer and synchronization pulse;

### DESCRIPTION OF THE PREFERRED EMBODIMENTS

The present invention is of a non-gyroscopic inertial North seeker system, and of a method for finding North. Specifically, the present invention is of a system and method for finding North based on the measurement of the Coriolis effect in a fluid rotor angular accelerometer.

The principles and operation of a North seeker based on a fluid rotor angular accelerometer according to the present invention may be better understood with reference to the drawings and the accompanying description.

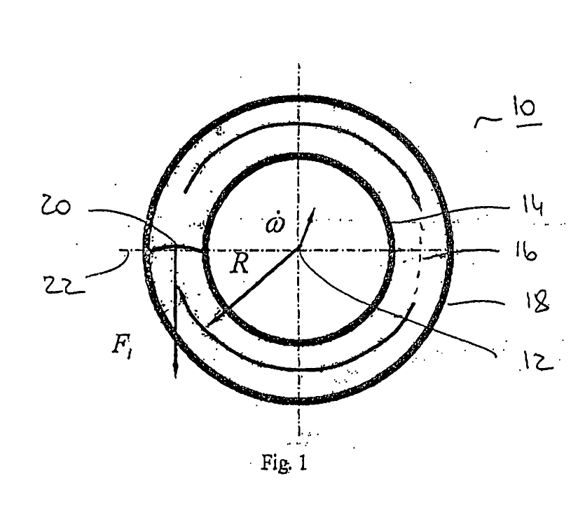

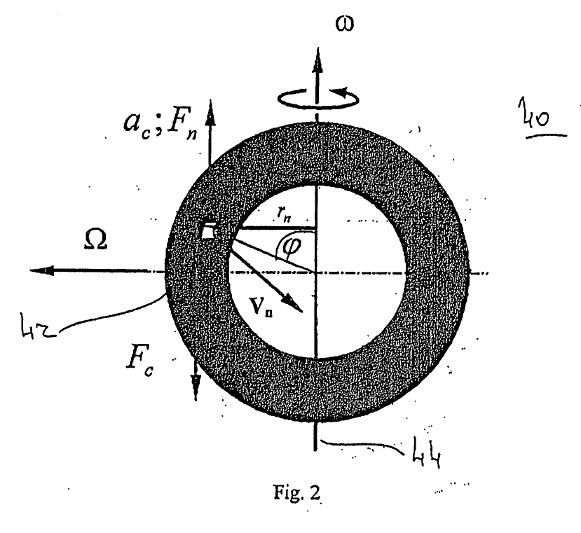

Referring now to the drawings, FIG. 2 shows schematically a Coriolis force acceleration measurement using a toroidal fluid rotor angular accelerometer. The figure shows a toroidal fluid rotor angular accelerometer 40 similar to accelerometer 20 of FIG. 1 which includes a sensing element 42. As in FIG. 1, sensing element 42 is preferably a piezo-ceramic membrane. Let us look at an elementary mass mₙ placed at a radius rₙ in the torus, which is now rotated around a vertical axis 44 (lying in the plane of the paper) with a velocity co. The mass feels a Coriolis acceleration a_{c}
a̅_{c}=2 Ω̅× V̅_{n a}_{c}=2Ωωrₙ; Fₙ=2Ωmₙωrₙ (3)
where Vₙ is the linear velocity of mₙ, produced by its rotation on radius rₙ, Fₙ is the elementary Coriolis force, and Ω is the inertial angular velocity on an axis perpendicular to axis 44. The integral Coriolis force applied to the piezo-ceramic membrane F_{c} is then given by the integration of all masses over a quarter torus (e.g. over the angle φ between 0 and 90°)

$${F}_{c} = 4 Ω ω {\int }_{0}^{π / 2} ρ {SR}^{2} φ {Sin}^{2} φ ⅆ φ ; \\ {F}_{c} = 4 Ω ωρ {SR}^{2} {\int }_{0}^{π / 2} φ {Sin}^{2} φ ⅆ φ ; \qquad ( 4 )$$

where ρ is the fluid density, R is the torus mean radius, S is the torus cross-section.

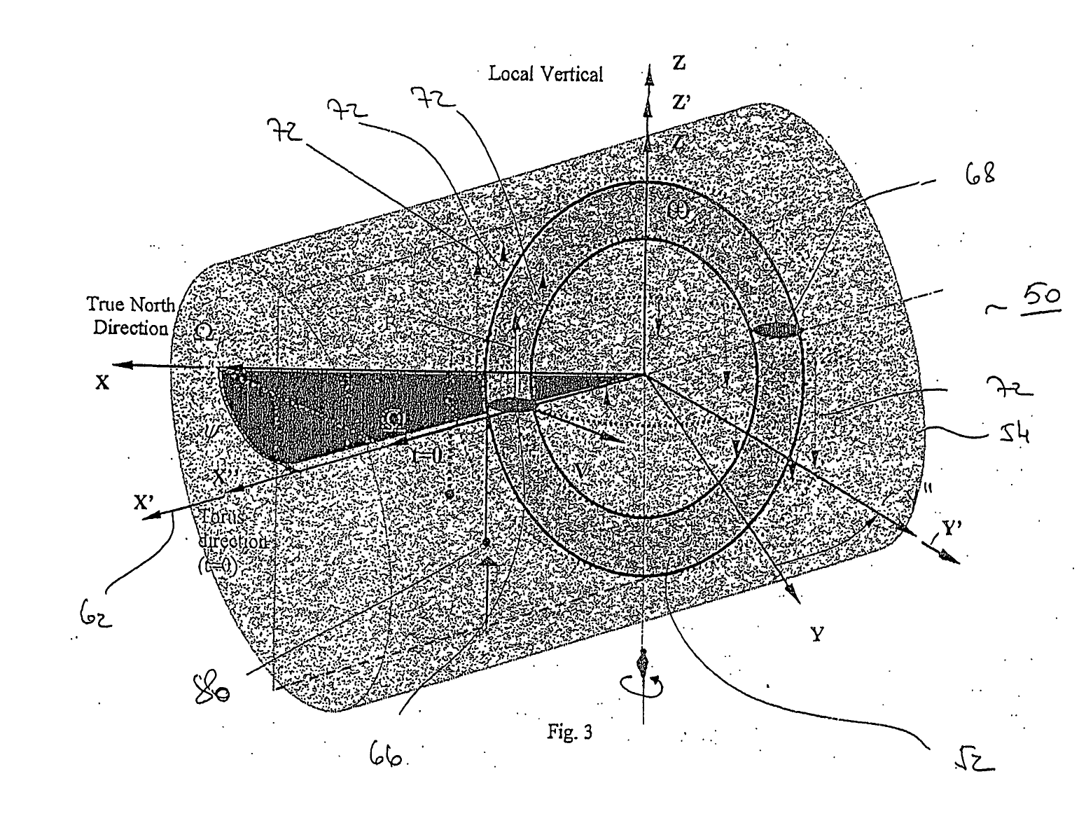

FIG. 3 shows schematically a preferred embodiment of a system 50 for North seeking of the present invention. System 50 includes a toroidal fluid rotor angular accelerometer 52 located on a body 54. The earth coordinates are given by an orthogonal axis set (X, Y, Z), with “Local Vertical” being Z, and true North being X. The body is defined by a body coordinate system, which in this case consists of orthogonal axes X′, Y′, Z′. The accelerometer is defined by an accelerometer coordinate system, which in this case consists of orthogonal axes X″, Y″, Z″. Body 54 seeks to find a body azimuthal direction 62 vs. the geographical North direction 60. This azimuthal position is defined by an angle ψ between body direction (axis X′) 62 and North direction (axis X) 60. In general, the body and the accelerometer (torus) local coordinate systems do not overlap. Thus, while the vertical (Z, Z′,Z″) axes overlap as shown, the other two orthogonal axes of body and torus do not do so (except once every rotation, as explained below). As in FIGS. 1 and 2, accelerometer 52 includes one sensing element 66, which is preferably a piezo-ceramic membrane. Optionally, accelerometer 52 may include a second piezo-ceramic membrane 68. The positioning of each membrane is identical with that described in FIG. 2.

As in FIG. 2, the accelerometer (torus) is rotated around a vertical (in the plane of the paper) axis 70 (which coincides with Z) with an angular velocity co relative to the body. Since both the body and the accelerometer are located on earth,
Ω=Ωₕ cos(ωt+Ψ)
where Ωₕ=|Ωₑₐᵣₜₕ| cos λ is the horizontal component of the earth rate, λ is the latitude, and ψ is body azimuth position. Membrane 66 now experiences a Coriolis force F_{c} from the combined contributions of torus and earth rotations:

$$\begin{matrix}{F}_{c} = 4 ( {Ω}_{h} cos ( ω t + Ψ ) ) ω ρ {SR}^{2} {\int }_{0}^{π / 2} φ {Sin}^{2} φ ⅆ φ \\ or & ( 5 ) \\ {F}_{c} = {Ω}_{h} π ω ρ {SR}^{2} cos ( ω t + Ψ ) & ( 6 )\end{matrix}$$

As indicated by equation 6, F_{c} is periodic (sinusoidal). This is shown in FIG. 3 by arrows 72 of changing length. F_{c} is positive (upwards) for half a rotation cycle (180 degrees) and negative (downwards) for the other half. The deflection of the piezo-ceramic membrane caused by F_{c} is transduced by known means into a periodic electrical output voltage Uₒᵤₜ
Uₒᵤₜ=k_{piezo}ΩₕπωρSR² cos(ωt+Ψ) (7)
where k_{piezo} is a transducing factor.

The relative azimuthal position vs North is extracted from Uₒᵤₜ. The means to extract the position include synchronization means in the form of a “zero” marker encoder 80 connected to system 50. Encoder 80 provides one pulse per full 360° revolution of the torus in body coordinates. The encoder produces this synchronization pulse when the body direction X′ coincides with the torus direction X″. An example of such an encoder may be a light source and a light detector positioned relative to the torus in such a way that a marker on the rotating torus cuts a light signal transmitted between the source and detector once every fall 360° revolution.

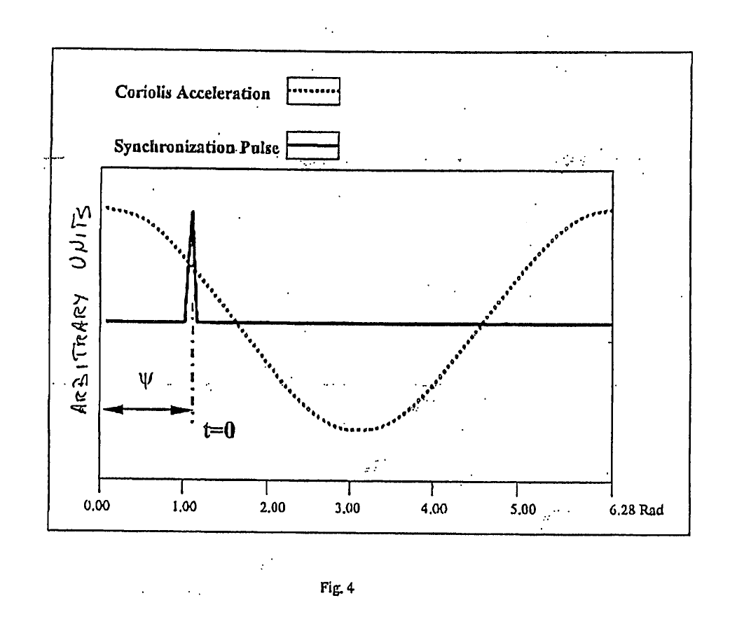

The periodic electrical signal from the rotative base piezo-ceramic membranes are amplified by a charge amplifier and transmitted through means such as brushless slip-rings to the static body. This signal is sampled-many times a revolution and over a large number of revolutions, and acquired together with a synchronization pulse provided by encoder 80. After acquisition, this periodic signal is filtered by averaging over a large number of complete revolutions. The following Fourier series may now express the output of the accelerometer, using the synchronization and periodic signals:
For t=0: Uₒᵤₜ=A₀+A₁ sin (ω·n/fₛₐₘₚ)+B₁ cos(ω·n/fₛₐₘₚ) (8)
where n is the sampling serial number, and fₛₐₘₚ is the sampling frequency. Since sin(x) and cos(x) are synchronized with the pulse signal provided by the zero encoder, the value of the Fourier coefficients A₀, A₁ and B₁ can be determined by a fit of the data points in FIG. 4, preferably by a least squares method. The relative North angle is then given by

$$ψ = arc tg ( \frac{A 1}{B 1} ) \qquad ( 9 )$$

All publications, patents and patent applications mentioned in this specification are herein incorporated in their entirety by reference into the specification; to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A non-gyroscopic inertial seeker system for determining the azimuth of a body relative to the true North direction, comprising:
a) a fluid rotor angular accelerometer positioned on and revolving on the body, said accelerometer providing a periodic output signal, and
b) means to extract from said periodic output signal the body azimuthal direction relative to the true North direction.

2. The inertial seeker system of claim 1, wherein said accelerometer includes at least one sensing element for sensing a Coriolis force correlated with said revolutions.

3. The inertial seeker system of claim 2, wherein said at least one sensing element includes a piezo-ceramic membrane, and wherein said periodic output signal is a periodic electrical voltage transduced from a deflection of said membrane caused by said Coriolis force.

4. The inertial seeker system of claim 1, wherein said means to extract include synchronization means for providing a synchronization pulse signal.

5. The inertial seeker system of claim 4, wherein said synchronization signal is used in combination with said periodic output signal to calculate coefficients of a Fourier series representing the output of said accelerometer.

6. The inertial seeker system of claim 5, wherein body azimuthal direction relative to the true North direction is calculated from said Fourier coefficients using equation 9.

7. A method for determining the azimuth of a body relative to the true North direction, comprising steps of:
a) providing a fluid rotor angular accelerometer, said accelerometer including at least one Coriolis force sensing element,
b) rotating said angular accelerometer relative to the body to provide a periodic output signal correlated with a body direction, and
c) using said periodic output signal to determine the azimuth of said body direction relative to the true North direction.

8. The method of claim 7, wherein said sensing element includes a piezo-ceramic membrane having a deflection in response to said Coriolis force.

9. The method of claim 8, wherein said deflection is periodical in response to said body direction, wherein said periodic output signal is an electrical voltage, and wherein said periodic deflection is transduced into said periodic electrical voltage.

10. The method of claim 9, wherein said step of using said periodic output signal includes using a synchronization pulse signal and an average of said periodic electrical voltage to produce a Fourier series having Fourier coefficients.

11. The method of claim 10, wherein said Fourier coefficients are used to calculate said azimuth of said body direction relative to the true North direction.

12. The method of claim 11, wherein said calculation is done according to equation 9.
